(19) United States
(12) Patent Application Publication
(10) Pub. No.: US 2018/0273101 A1
(43) Pub. Date: Sep. 27, 2018

(54) Motorised Karts

(71) Applicant: Warren Scott, Hertfordshire (GB)

(72) Inventor: Paul Martin, Hertss (GB)

(21) Appl. No.: 15/532,729

(22) PCT Filed: Dec. 2, 2015
(86) PCT No.: PCT/GB2015/053689

§ 371 Date: Jun. 2, 2017

(30) Foreign Application Priority Data
Dec. 2, 2014 (GB) 1421435.7

(51) Int. Cl. B62D 21/18; B60G 7/02; B60G 3/20

(52) U.S. Cl. CPC B62D 21/183; B60G 7/02; B60G 3/20; B60G 2200/46; B60G 2200/4622; B60Y 2200/114; B60G 2204/15; B60G 2204/18; B60G 2204/19; B60G 2300/26; B60G 2204/143

(57) ABSTRACT

A motorised kart (10) has a chassis (12), a front wheel axle (14), an engine (16) mounted to the chassis and a transmission to transmit drive from the engine to the front wheel axle. The transmission includes a differential unit (20).

### FIELD OF THE INVENTION

The invention relates to motorised karts.

### BACKGROUND TO THE INVENTION

Motorised karts, sometimes known as go-karts, are small motorised vehicles used for recreational purposes, including kart racing. Known karts comprise a rigid chassis on which are mounted an engine, seat for the driver and a steering system. The engine is mounted behind the seat. In order to drive the rear wheels of the kart the engine is connected to a solid rear axle by means of a chain and sprockets. Typically the rear wheels are larger than the front wheels. Karts do not have a suspension system. That is to say, a kart does not have any hydraulic, pneumatic, spring or elastomeric elements for damping chassis oscillation.

### SUMMARY OF THE INVENTION

The invention provides a motorised kart as specified in claim 1.

The invention also includes a motorised kart as specified in claim 15.

### BRIEF DESCRIPTION OF THE DRAWINGS

In order that the invention may be well understood, some examples thereof, which are given by way of example only, will now be described with reference to the drawings in which:

FIG. 1 is a schematic perspective view of a motorised kart;

FIG. 2 is a schematic side elevation of the motorised kart of FIG. 1;

FIG. 3 is a schematic plan view of a front axle of the motorised kart of FIG. 1;

FIG. 4 is a schematic perspective view of a front wheel support structure and wheel hub of the motorised kart of FIG. 1;

FIG. 5 is a schematic perspective view of a front wheel support structure and a front wheel assembly of the motorised kart of FIG. 1;

FIG. 6 is a schematic front elevation of the front wheel support structure and front wheel assembly of FIG. 5;

FIG. 7 is schematic front elevation of a rear wheel support structure and rear wheel assembly of the motorised cart of FIG. 1;

FIG. 8 is a plan view of another motorised kart with the engine and bodywork removed;

FIG. 9 is a side view of the motorised kart of FIG. 8;

FIG. 10 is a perspective view of the front axle of the motorised kart of FIG. 8; and

FIG. 11 is a perspective view showing the front axle and engine of the motorised kart of FIG. 8.

### DETAILED DESCRIPTION OF THE ILLUSTRATED EXAMPLES

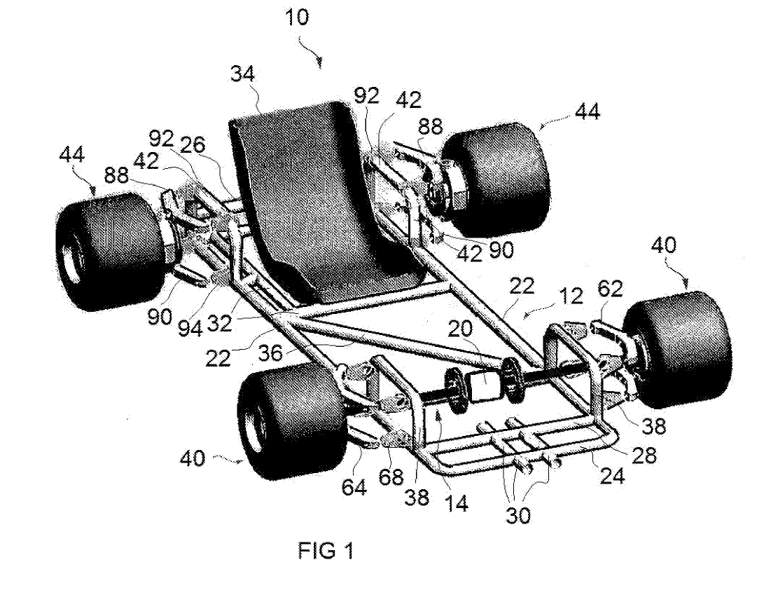

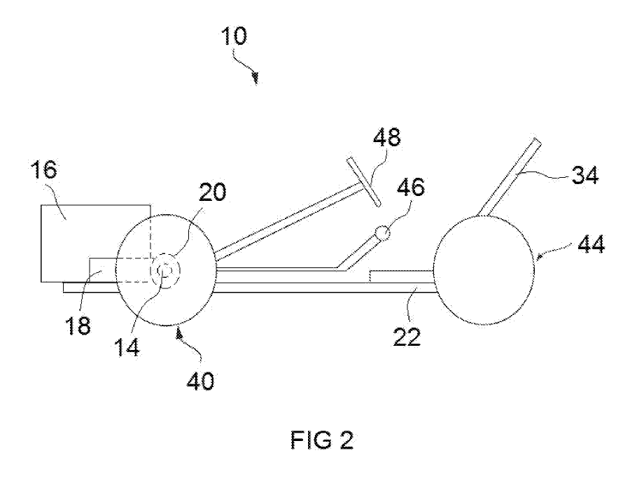

Referring to FIGS. 1 and 2, a motorised kart 10 comprises a chassis 12, a front wheel axle 14 and an engine 16. The engine 16 is secured to the chassis such that it is disposed in front of the front wheel axle 14. The engine 16 may be a 2-stroke or 4-stroke internal combustion engine. The motorised kart 10 further comprises a transmission 18, 20 to transmit drive from the engine 16 to the front wheel axle 14. The transmission may comprise a gearbox 18 connected to an output shaft of the engine 16 and a differential unit 20 arranged to transmit the rotary output of the gearbox to the front wheel axle 14. In the illustrated example, the engine 16, gearbox 18 and differential unit 20 directly engage one another to transmit drive from the engine to the front wheel axle 14.

The chassis 12 may be fabricated from a plurality of suitably stiff members and may be fully welded. The chassis may, for example, comprise a plurality of tubes, which may be 31 mm steel tubes. The chassis 12 may comprise two side members 22 disposed in generally parallel opposed spaced apart relation and oppositely disposed transversely extending leading and trailing end members 24, 26 that connect the ends of the side members 22 to form a generally rectangular frame. A cross member 28 is provided between the side members 22 adjacent, but spaced apart from, the leading end member 24 and ahead of the front wheel axle 14. A plurality of members 30 that extend in the lengthways direction of the chassis 12 (in this example six) are welded to one or both of the cross member 28 and leading end member 24 to form with the cross member 28 and leading end member 24 a platform for the engine 16. The engine 16 can be secured to the chassis 12 by any suitable conventional means that will be known to the skilled person (for example brackets, vibration isolators, screws and nuts and bolts) so the securing of the engine to the chassis is not illustrated and will not be described in detail herein.

A plurality of chassis members 32 are welded to the rectangular main frame to provide mounting points for a seat 34. The seat 34 may be a plastics moulded bucket seat and may, optionally be padded for comfort. In the illustrated example, the seat 34 is centrally disposed in the widthways direction of the chassis 12. One or more strengthening members 36 may be provided between the side members 22 to stiffen the rectangular main frame. The strengthening members 36 may extend perpendicular to the side members 22 or at an acute angle to the side members as illustrated by way of example in FIG. 1.

Two generally U-shaped front wheel mounting members 38 are secured to the side members 22 towards the front of the chassis 12. The front wheel mounting members 38 cooperate with the side members 22 to provide respective mounting points for the two wheel assemblies 40 of the front wheel set. The front wheel mounting members 38 are disposed in opposed spaced apart relation and extend upwardly from the plane of the rectangular main frame. Similarly, two generally U-shaped rear wheel mounting members 42 are secured to the side members 22 towards the rear of the chassis 12. The rear wheel mounting members 42 cooperate with the side members to provide respective mounting points for the two wheel assemblies 44 of the rear wheel set. The rear wheel mounting members 42 are disposed in opposed spaced apart relation and extend upwardly from the plane of the rectangular frame. Although not essential, in the example illustrated by FIGS. 1 to 7 the front and rear wheel mounting members 38, 42 stand perpendicular to the rectangular frame.

As shown in FIG. 2, gear stick 46 connected with the gearbox 18 and a steering wheel 48 connected with the front wheel assemblies 40 are provided adjacent the seat 34 to allow a driver to control the motorised kart 10.

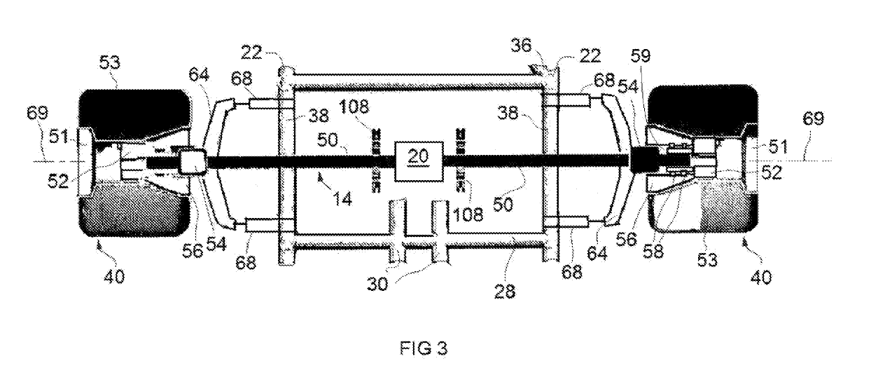

Referring to FIGS. 3 to 6, the front wheel axle 14 comprises two half shafts 50. The half shafts 50 extend from the differential unit 20 to the respective front wheel assemblies 40. The front wheel assemblies 40 each comprise a front wheel 51 secured to a wheel hub 52 and a tyre 53 fitted to the wheel. The outboard ends of the half shafts 50 are connected to the respective wheel hubs 52 by constant velocity joints 54.

Each front wheel assembly 40 is connected to the chassis 12 and supported by a wheel support structure that comprises a steering knuckle 56, rolling bearings 58 and a wishbone system 60, 62. Since the two wheel support structures are identical, for economy of presentation, just one will be described in detail.

The steering knuckle 56 comprises a body defining a through-hole 59 (FIG. 3) that houses a pair of rolling bearings 58 that support the wheel hub 52 such that the wheel hub can rotate relative to the steering knuckle. The constant velocity joint 54 connects with the steering hub 52 within the through-hole 59 so that the front wheel 51 can be turned by a torque transmitted by the half shaft 50.

In the example illustrated by FIGS. 1 to 7, the wheel support structure comprises a double wishbone system that comprises an upper wishbone 62 and a lower wishbone 64. The wishbones 62, 64 connect the steering knuckle 56 to the chassis 12. The wishbones 62, 64 may be at least substantially identical in shape as illustrated and are disposed in vertically opposed spaced apart relation so that the half shaft 50 can extend between them. The upper wishbone 62 has respective swivel joints 66 at its free ends by which it is secured to a transverse portion 38T (FIG. 5) of the front wheel mounting member 38 that extends generally parallel to and above the side member 22 to which the wheel mounting member is joined. The lower wishbone 64 has respective swivel joints 68 at its free ends by means of which it is secured to the side member 22. The swivel joints 66, 68 allow pivoting of the front wheel assembly 40 relative to the chassis 12 to allow the camber of the front wheel 51 to be adjusted and set. That is the swivel joints 66, 68 allow the front wheel 51 to pivot about respective pivot axes extending in the lengthways direction of the chassis 12 as defined by the side member 12 and transverse portion 38T of the front wheel mounting member. The axis of rotation 69 of the front wheel axle 14 extends transverse to the pivot axes defined by the side member 22 and transverse portion 38T.

It will be known by those skilled in the art that if the vertical alignment of the front wheels of a vehicle is perpendicular to the road surface, the wheels have zero camber (the camber angle is 0°). The camber is negative if the tops of the wheels tilt inwards towards the chassis and positive if the tops of the wheels tilt way from the chassis. The pivoting of the front wheel 51 allowed by the swivel joints 66, 68 allows the camber of the front wheels to be adjusted and set at a desired camber angle. The handling of the motorised kart 10 can be modified by adjusting the camber of the front wheels 51.

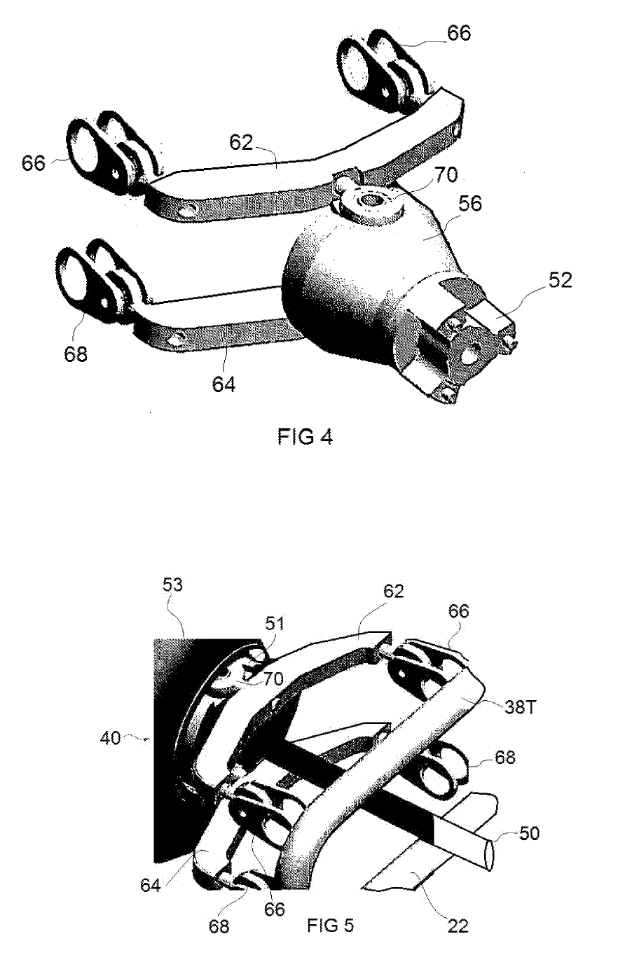

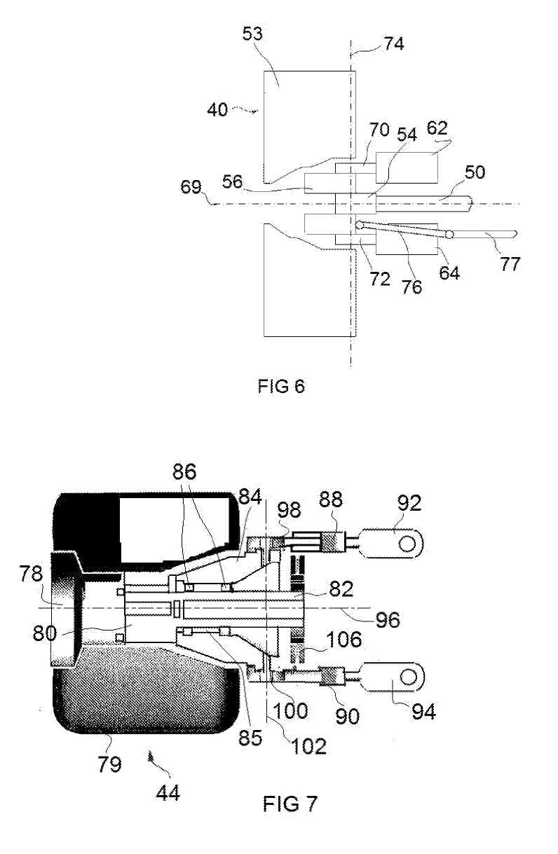

Referring to FIGS. 4 to 6, the steering knuckle 56 is connected to the upper and lower wishbones 62, 64 by respective upper and lower swivel joints 70, 72. The swivel joints 70, 72 are secured to and extend from the centre of the respective wishbones 62, 64 and are disposed in opposed spaced apart relation. The swivel joints 70, 72 define a pivot axis 74 (FIG. 6) that extends transverse to the axis of rotation 69 of the front wheel axle 14 and the axes about which the swivel joints 66, 68 can pivot. In an XYZ coordinate system, the swivel joints 66, 68 can be considered to pivot about at least an approximation to an X axis, the axis of rotation of the front wheel axle 14 can be considered at least an approximation of the Y axis and the pivot axis 74 can be considered at least an approximation of the Z axis. In the illustrated example, the pivot axis 74 is coincident with the Z axis of the constant velocity joint 54 and is preferably disposed in line with the inboard rim of the front wheel 51 or further towards the centre of the wheel 51 to keep it close to the contact patch of the wheel.

As shown in FIG. 6, the steering knuckle 56 is pivot connected to a first end of a tie rod 76. The second end of the tie rod 76 is connected to a rack and pinion steering system 77 that can be operated by turning the steering wheel 48. The tie rod 76 is operable to allow the toe of the front wheel 51 to be adjusted and set. As is known by those skilled in the art, positive toe occurs when the fronts of the front wheels point inwardly towards each other, or the lengthways extending centre line of a vehicle, and negative toe occurs if the fronts of the front wheels point away from one another or the centre line. By suitable operation of the tie rods 76, the front wheels 51 can be made to point ahead or have a positive or negative toe as desired by causing them to pivot about their respective pivot axes 74.

Referring to FIGS. 1 and 7, the rear wheel assemblies 44 and their respective wheel support structures are identical and so just one will be described in detail. Each rear wheel assembly 44 comprises a rear wheel 78, a tyre 79 fitted to the wheel, a wheel hub 80 to which the wheel is secured and a stub axle 82 that in the illustrated example is integral with the wheel hub and extends from the inboard side of the wheel hub. The stub axles 82 define the rear axle of the motorised kart 10.

The rear wheel support structure comprises a hub mounting 84 and a wishbone system by which the hub mounting is connected to the chassis 12. The hub mounting 84 has a through-hole 85 in which two rolling bearings 86 are housed. The stub axle 82 extends through the through-hole 85 and engages the rolling bearings 86 so that the wheel hub 80 is supported by the rolling bearings for rotation relative to the hub mounting.

The wishbone system of the rear wheel support structure is a double wishbone system that comprises an upper wishbone 88 and a lower wishbone 90. The wishbones 88, 90 may be at least substantially identical in shape as illustrated and are disposed in vertically opposed spaced apart relation so that the stub axle 82 can extend between them. The upper wishbone 88 has respective swivel joints 92 at its free ends by which it is secured to the transverse portion of the rear wheel mounting member 42 that extends generally parallel to and above the side member 22 to which the wheel mounting member is joined. The lower wishbone 90 has respective swivel joints 94 at its free ends by means of which it is secured to the side member 22. The swivel joints 92, 94 allow pivoting of the rear wheel assembly 44 relative to the chassis 12 to allow the camber of the rear wheel 78 to be adjusted and set. That is the swivel joints 92, 94 allow the rear wheel 40 to pivot about respective pivot axes extending in the lengthways direction of the chassis 12 as defined by the side member 12 and transverse portion of the rear wheel mounting member 42. The axis of rotation of the wheel hub 80 defined by the stub axle 82 extends transverse to the pivot axes defined by the side member 22 and transverse portion of the rear mounting member 42. Thus, in analogous fashion to the front wheels 51, the pivoting of the rear wheel 78 allowed by the swivel joints 92, 94 allows the camber of the rear wheel to be adjusted and set at a desired camber angle. The handling of the motorised kart 10 can be modified by adjusting the camber of the rear wheels 78.

The hub mounting 84 is connected to the upper and lower wishbones 88, 90 by respective upper and lower swivel joints 98, 100. The swivel joints 98, 100 are secured to and extend from the centre of the respective wishbones 88, 90 and are disposed in opposed spaced apart relation. The swivel joints 98, 100 define a pivot axis 102 that extends transverse to the axis of rotation 96 of wheel hub 80. In an XYZ coordinate system the swivel joints 92, 94 can be considered to pivot about at least an approximation of an X axis, the axis of rotation 96 of the wheel hub 80 can be considered at least an approximation of the Y axis and the pivot axis 102 can be considered at least an approximation of the Z axis. Unlike the pivot axis 74, the pivot axis 102 is disposed externally of and away from the rear wheel 78. This allows a rear brake disc 106 to be fitted on the stub axle 82 adjacent the hub mounting 84. In the same way as with the front wheels 51, the swivel joints 98, 100 connecting the hub mounting 84 to the double wishbone system 88, 90 permit pivoting of the rear wheel assembly 44 relative to the chassis 12 for adjusting and setting the toe of the rear wheels 78.

In addition to the rear brake discs 106, the braking system of the motorised kart 10 comprises respective front brake discs 108 mounted on the half shafts 50 adjacent the differential unit 20. The braking system may additionally comprise respective callipers for the brake discs 106, 108 and a hydraulic actuating system. Brake systems for motor vehicles will be familiar to those skilled in the art and so will not be described in detail herein.

In the example illustrated by FIGS. 1 to 7, the engine 16 is mounted transversely on the chassis 12 and the transmission comprises a gearbox 18 taking drive directly from the output shaft of the engine and engaging with the differential unit 20 to drive the half shafts 50. In other examples, the drive from the gearbox 18 to the differential unit 20 may be transmitted using a flexible transmission system using sprockets and a chain, or toothed wheels and a toothed belt.

Each of the front wheels of the motorised kart 10 is supported by a double wishbone system. In other examples a single wishbone and a cooperating pivoting strut may be used instead.

In the illustrated example illustrated by FIGS. 1 to 7, a cross member 28 and a plurality of members 30 cooperate with the leading end member 24 to provide a platform for the engine 16. It will be understood that in some examples the member 28 or members 30 may be omitted and in some cases a plate or the like may be secured to the chassis 12 to provide a mounting for the engine.

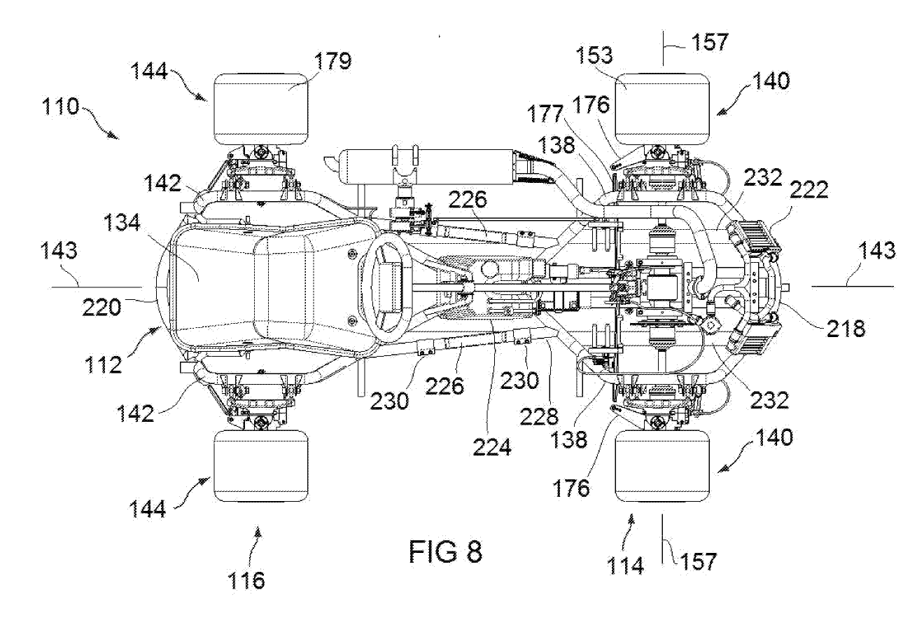

Another motorised kart 110 is illustrated by FIGS. 8 to 11. Many features of the motorised kart 110 correspond to or are similar to features of the motorised kart 10. Such features are indicated by the same reference numerals incremented by 100 and may not be described again.

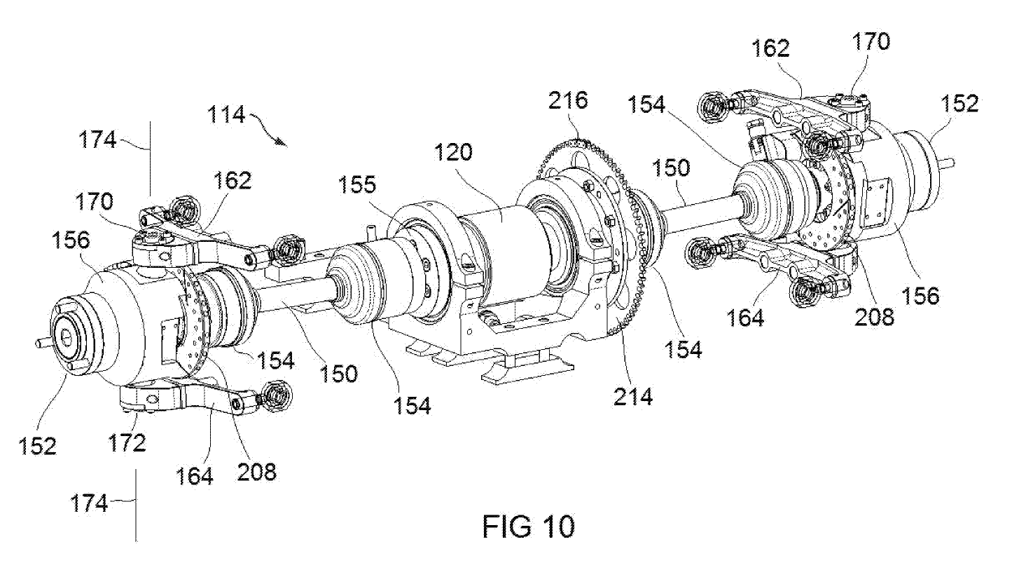

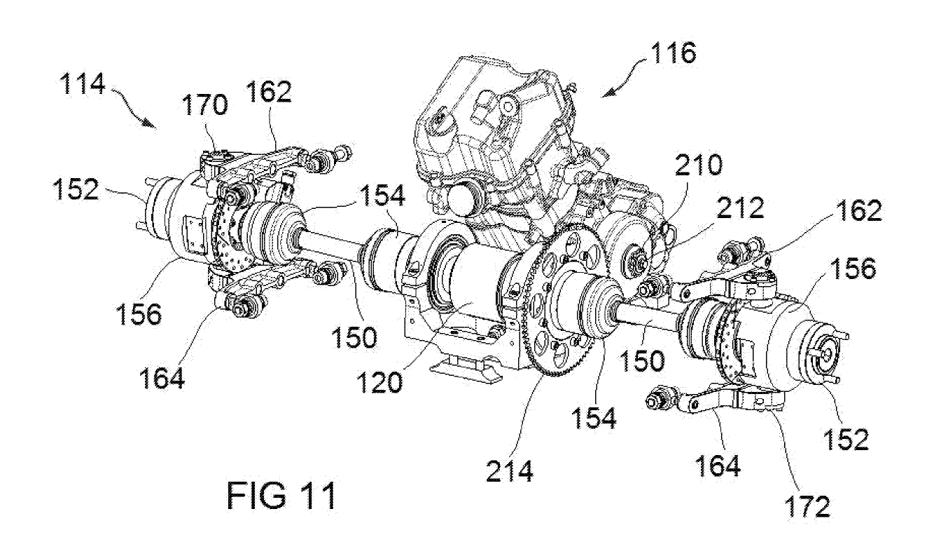

The motorised kart 110 comprises a chassis 112, a front wheel axle 114 and an engine 116. The engine 116 is secured to the chassis 112 forwardly of the front wheel axle 114 and may be a 2-stroke or 4-stroke petrol engine that may be inclined with respect to the vertical so that its upper end portions are disposed further from the forward end of the motorised kart than are the lower end portions. As illustrated by FIGS. 10 and 11, the motorised kart 110 further comprises a transmission that may comprise a differential unit 120 arranged to transmit the rotary output of the engine 116 to the front wheel axle 114, a sprocket 210 fixed to the output shaft 212 of the engine and a sprocket 214 connected with an input member of the differential unit and connected with the sprocket 210 by means of a chain 216 (indicated partially in FIG. 11). The output shaft 212 extends transversely with respect to the chassis 112.

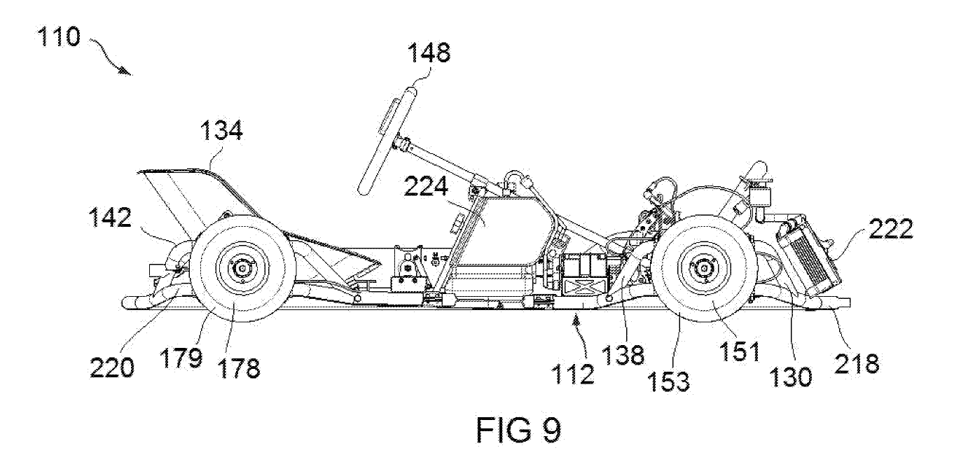

The chassis 112 may be fabricated from a plurality of stiff members. The chassis 112 may comprise tubes welded to one another as shown in FIGS. 8 and 9. The chassis 112 may comprise a front main chassis portion 218 and a rear main chassis portion 220. The front main chassis portion 218 forms a continuous frame that extends forwardly below the front axle 114 to a front end at which a radiator 222 is mounted and rearwardly below a petrol tank 224. The rear main chassis portion 220 is a generally U-shaped frame that has free ends connected to opposed side members 226 that are connected to respective stubs 228 projecting from the front main chassis portion 218. The side members 226 may be connected with the rear main chassis portion 220 and stubs 228 by means of clamps 230 or by welding. Engine mounting chassis members 232 extend in the lengthways direction of the chassis 112 between the opposite ends of the front main chassis portion 218. The engine mounting chassis members 232 may extend from the front end of the front main chassis portion to the rear end of the rear main chassis portion 220 to stiffen the chassis 112.

Two generally U-shaped front wheel mounting members 138 are secured to opposite sides of the front main chassis portion 218 and extend upwardly with respect to the front main chassis portion. Similarly, two generally U-shaped rear wheel mounting members 142 are secured in opposed spaced apart relation to the rear main chassis portion 220. The rear wheel mounting members 142 extend upwardly with respect to the rear main chassis portion 220. The front and rear wheel mounting members 138, 142 may be inclined outwardly with respect to the centre line 143 of the chassis 112. The front wheel mounting members 138 cooperate with the front main chassis portion 218 to provide respective mounting points for the two front wheel assemblies 140. The rear wheel mounting members 142 cooperate with the rear main chassis portion 220 to provide respective mounting points for the two rear wheel assemblies 144.

Referring to FIG. 10, the front wheel axle 114 comprises two half shafts 150 that are connected with the differential unit 120 and front wheel assemblies 140 by respective constant velocity, or universal, joints 154. The universal joints 154 disposed at the inboard ends of the half shafts 150 are secured to respective output members, or flanges, 155 of the differential unit 120 (only one of which can be seen in FIG. 10). The flanges 155 rotate about a common axis 157 (FIG. 8) that may be disposed parallel to the axis of rotation of the engine output shaft 210. The engine 116 is mounted to the engine mounting chassis members 232 such that it is disposed forwardly of the front wheel axle 114. In some examples, parts of the engine 116 may be disposed over or rearwardly of the front wheel axle, but the arrangement is such that the axis of rotation of the output shaft 210 is forwards of the differential unit 120, or at least of the common axis 157.

The front wheel assemblies 140 and associated wheel support structures correspond generally to the front wheel assemblies 40 and wheel support structures illustrated by FIGS. 3 to 6 and function in the same way in allowing adjustment of the camber and toe in of the front wheels. Thus each front wheel assembly 140 comprises a front wheel 151 mounted on a wheel hub 152 fitted with a tyre 153. The wheel hubs 152 are connected with a respective half shaft 150 via a universal joint 154. The front wheel support systems each comprise a double wishbone system comprising an upper wishbone 162 swivel connected with a respective front wheel mounting member 138 and a lower wishbone 164 swivel connected with the front main chassis portion 218. The front wheel support systems further comprise respective steering knuckles 156 swivel connected with the upper and lower wishbones by respective upper and lower swivel joints 170, 172, which define a pivot axis 174. The steering knuckles 156 are connected with a steering system by respective linkages 176, 177. The camber of the front wheel assemblies 140 can be adjusted by the pivoting of the double wishbone systems with respect to the front wheel mounting member 138 and front main chassis portion 218 and the toe of the front wheel assemblies 140 can be set by adjusting the linkages 176, 177 to cause the front wheel assemblies to pivot about the respective pivot axes 174. The difference between the front wheel assemblies 140 and the front wheel assemblies 140 is that the respective pivot axes 174 are disposed externally of the front wheels 151 and the wheel hubs 152 project beyond the inboard rims of the front wheels so that respective brake discs 208 can be fitted to the front wheel hubs.

The rear wheel assemblies 144 correspond to the rear wheel assemblies 44 of the motorised kart 10 and so for economy of presentation will not be described again.

It is to be understood that by mounting the engine ahead of the front axle, or so the output shaft is forwards of the differential unit, or at least ahead of the axis of rotation of the output members of the differential unit, the weight of the engine is located such that the motorised kart has handling characteristics that are significantly different to conventional karts that have the engine mounted behind the driver's seat. Motorised karts may be used as a race training vehicle for young drivers prior to stepping up to racing saloon cars and the like. However, the handling characteristics of conventional motorised karts are significantly different to those of racing saloon cars. By mounting the engine in front of the differential unit, or at least with the output shaft of the engine disposed forwardly of the axis of rotation of the output members of the differential unit is it is possible to provide a motorised kart that better simulates the handling of a racing saloon car and so provides a better training vehicle for young drivers. Furthermore, providing a motorised kart with front and rear wheels with adjustable toe and camber facilitates the set up of the motorised kart to better simulate a racing saloon car and so provide a better training vehicle for a young driver. Still further, providing a front wheel driven motorised kart with front wheels driven via a differential unit makes the motorised kart handle more like a racing saloon car, many of which are front wheel drive vehicles.

1. A motorised kart comprising a chassis, a front wheel axle, a plurality of wheels connected with said front wheel axis, an engine mounted to said chassis and a transmission to transmit drive from said engine to said front wheel axle, wherein said transmission comprises a differential unit.

2. A motorised kart as claimed in claim 1 or 2, wherein said front wheels connect with said front wheel axle via respective constant velocity joints.

3. A motorised kart as claimed in claim 1 or 2, wherein said front wheels are connected with said chassis by respective front wheel support structures configured to permit adjustment of the camber of said front wheels.

4. A motorised kart as claimed in claim 3, wherein said wheel support structures each comprise a double wishbone system.

5. A motorised kart as claimed in claim 3 or 4, wherein the respective front wheel support structures are configured to permit adjustment of the toe of said front wheels.

6. A motorised kart as claimed in claim 5, wherein said front wheel support structures are configured to permit pivoting of said front wheels about respective pivot axes disposed in line with an inboard rim of the wheel or between the inboard rim and an outboard rim of the wheel to permit said adjustment of the toe of said front wheels.

7. A motorised kart as claimed in any one of claims 1 to 5, further comprising respective brake discs mounted to said front wheels.

8. A motorised kart as claimed in any one of the preceding claims, further comprising a rear wheel axle, a plurality of rear wheels connected with said rear axle and respective rear wheel support structures connecting said rear wheels with said chassis, said rear wheel support structures being configured to permit adjustment of the camber of said rear wheels.

9. A motorised kart as claimed in claim 8, wherein the respective wheel support structures are configured to permit adjustment of the toe of said rear wheels.

10. A motorised as claimed in claim 7 or 8, wherein said front and rear wheels are the same size.

11. A motorised kart as claimed in claim 8, 9 or 10, wherein each said rear wheel support structure comprises a double wishbone system.

12. A motorised kart as claimed in any one of the preceding claims, wherein said engine is mounted to said chassis forwardly of said front wheel axle.

13. A motorised kart as claimed in any one of the preceding claims, wherein said engine comprises an output shaft that extends transversely with respect to said chassis and said output shaft is disposed forwardly of said differential unit.

14. A motorised kart as claimed in any one of claims 1 to 12, wherein said differential unit comprises opposed output members having a common axis of rotation and said engine comprises an output shaft that extends parallel to and is disposed forwardly of said common axis.

15. A motorised kart comprising a chassis, a front wheel axle, a plurality of front wheels connected with said front wheel axle, a rear axle, a plurality of rear wheels connected with said rear wheel axle and an engine, wherein said engine is mounted to said chassis in front of said front wheel axle.

16. A motorised kart as claimed in claim 15, further comprising a transmission connecting said engine with said front wheel axle to permit said engine to drive said front wheel axle.

17. A motorised kart as claimed in claim 16, wherein said front wheel axle comprises two half shafts and said transmission comprises a differential unit connected with said half shafts.

18. A motorised kart as claimed in claim 17, wherein said engine has an output shaft extending transversely with respect to said chassis and disposed forwardly of said differential unit.

19. A motorised kart as claimed in claim 17, wherein said engine has an output shaft extending transversely with respect to said chassis, said differential unit comprises opposed output members rotatable about a common axis and said output shaft is disposed forwardly with respect to said common axis.

20. A motorised kart as claimed in claim 17, 18 or 19, wherein respective outboard ends of said half shafts are fitted with constant velocity joints to connect with respective rotational elements connected with said front wheels.

21. A motorised kart as claimed in any one of claims 16 to 20, wherein said transmission comprises a flexible drive transmission element to transmit drive from said engine to said differential unit.

22. A motorised kart as claimed in any one of claims 15 to 21, wherein said front and rear wheels are the same size.

23. A motorised kart as claimed in any one of claims 15 to 22, further comprising a wheel support structure connected with said chassis to support a said wheel, wherein said wheel support structure is configured to permit adjustment of at least one of:
1) the camber of said wheel; and
2) the toe of said wheel.

24. A motorised kart as claimed in claim 23, wherein said wheel support structure is configured to permit pivoting of said wheel with respect to said chassis about an axis extending in a lengthways direction of said chassis to permit said adjustment of the camber of said wheel.

25. A motorised kart as claimed in claim 23 or 24, wherein said wheel support structure comprises a steering knuckle that is pivotable about a pivot axis that extends in a radial direction of said wheel to permit said adjustment of the toe of the wheel.

26. A motorised kart as claimed in claim 25, wherein said wheel has an inboard rim and an outboard rim and said pivot axis is disposed in line said inboard rim or between said inboard and outboard rims.

27. A motorised kart as claimed in any one of claims 23 to 26, wherein said wheel support structure comprises a wishbone system.

28. A motorised kart as claimed in claim 27, wherein said wheel support structure comprises a first wishbone and a second wishbone, said first wishbone is spaced from and disposed at least in part above said second wishbone and each wishbone has two free ends that are pivot connected to said chassis to permit pivoting of said wheel with respect to said chassis about an axis extending in a lengthways direction of said chassis to permit said adjustment of the camber of said wheel.

29. A motorised kart as claimed in claim 28, wherein said wheel support structure comprises a steering knuckle that is pivotable about a pivot axis that extends in a radial direction of said wheel to permit said adjustment of the toe of the wheel and said pivot axis is defined by respective swivel joints that connect said first and second wishbones with said steering knuckle.
